(19) United States
(12) Patent Application Publication
(10) Pub. No.: US 2007/0005583 A1
(43) Pub. Date: Jan. 4, 2007

(54) Method for building powerful calculations of an entity relationship model

(75) Inventors: Carolyn Khanh Chau, Carnation, WA (US); Jason David Carlson, Redmond, WA (US); Robert Alan Meyers, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/170,898

(22) Filed: Jun. 29, 2005

(51) Int. Cl. G06F 17/30

(52) U.S. Cl. 707/4

(57) ABSTRACT

A method of creating and defining complex functions and/or expressions that may be run against an entity relationship model. An anchor entity serves as a beginning point of the expression and determines what data that will be returned by the user-created expression within the context of a query. When a relationship from any entity is traversed, including the anchor entity, the role name for the target entity is displayed hierarchically beneath the entity it was navigated from. When an entity is selected, the relationships from this entity are shown as possible navigation paths. The user may select one of these paths to navigate and add to the query tree or chose a field from the field list. Entities can be dragged and dropped into a formula area to create the expression. Functions, and mathematical and logical operations can be performed on the entities and fields in creating the expression. The fields and entities can be filtered to refine the results retrieved by the expression.

### FIELD OF THE INVENTION

This invention relates in general to the field of entity relationship modeling. More particularly, this invention relates to a method of creating calculations that are performed on an entity relationship model.

### BACKGROUND OF THE INVENTION

An entity relationship (ER) diagram is a graphical representation of an organization's data storage requirements. Entity relationship diagrams are abstractions of the real world which simplify a problem to be solved while retaining its essential features. Entity relationship diagrams have three different components: entities, attributes and relationships. Entities are the people, places, things, events and concepts of interest. Entities may represent collections of things, for example, an employee entity might represent a collection of all the employees that work for an organization. Individual members (employees) of the collection are called occurrences of the employee entity.

Entities are further described by their attributes or data elements. These are the smallest units of data that can be described in a meaningful manner. For example, an employee entity may have the following attributes: employee number, last name, first name, date of birth, telephone number, department, etc. Frequently, a meaningful relationship exists between two different types of entity. For example: employees work in a department, lawyers advise clients, equipment is allocated to projects, truck is a type of vehicle, etc.

There are potentially three types of relationships which can exist between two different entities: one-to-one, one-to-many and many-to-many relationships. A one-to-one relationship is when a single occurrence of an entity is related to just one occurrence of a second entity. For example, a roof covers one building; a building is covered by one roof. One-to-many relationships are when a single occurrence of an entity is related to many occurrences of a second entity. For example, an employee works in one department; a department has many employees. Many-to-many relationships are when many occurrences of an entity are related to many occurrences of a second entity. For example, equipment is allocated to many projects; a project is allocated many items of equipment.

Because of the nature and flexibility of ER models, it can be difficult to construct powerful calculations. Much of the complexity comes from the relationships. In simpler models you only need to be concerned with attributes for example: Sales−Cost=Profit. The power and the complexity comes when there is a desire to see something more interesting, such as sales to men for woman's apparel around Mothers Day, vs. sales to women for men's apparel around Fathers day. For this type of calculation sales are described in terms of who bought them (men or women), when they were purchased (Mothers day or Fathers day) and the type of product (men's apparel or woman's). This requires filters on the relationship between the actual sales for a given type of product and another for the order for when it was purchased and the yet another for the customer who purchased it.

Conventional tools for creating calculations using ER models do not scale well to a user's level of experience. Such tools include Online Analytical Processing (OLAP) tools that provide analysis of data stored in a database. OLAP tools enable users to analyze different dimensions of multidimensional data. For example, it provides time series and trend analysis views. OLAP often is used in data mining. However, these tools are either too simple or too difficult to use.

### SUMMARY OF THE INVENTION

A method of creating and defining complex functions and/or expressions that may be run against an entity relationship model. A primary entity serves as a beginning point of the query and determines what data that will be returned by the user-created report. When a relationship from any entity is traversed, including the primary entity, the role name for the target entity is displayed hierarchically beneath the entity it was navigated from. A tree is formed from the primary entity to all other entities involved in the query which allows the user to easily see what entities and relationships are available to be used in the query. In addition, expressions may be anchored to any entity. When the expression is used in a report, the query changes according to the contents of the expression (either the field is anchored to the existing query or the base entity may change depending on the contents of the expression).

Also, when an entity is selected, the relationships from this entity are shown as possible navigation paths. The user may select one of these paths to navigate and add to the query tree or chose a field from the field list. It also allows the user to quickly return to any entity used in the query to add additional fields or traverse another relationship. If the user changes the primary entity during the building of a query, the navigation zone is reconstituted with the new primary entity at the root.

Entities and fields can be dragged and dropped into a formula area to create the expression. Functions and mathematical and logical operations can be performed on the entities and fields in creating the expression. The fields and entities can be filtered to refine the results retrieved by the expression. Users can also specify the level of aggregation within different parts of the expression and select the level of duplicate instances of items to be included in the calculation. The formula area behaves as an intelligent text box to guide the user in creating the expression which is run against the ER model.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented; and

FIGS. 2-10 illustrate aspects of building an expression.

### DETAILED DESCRIPTION OF PREFERRED EMBODIMENTS

Exemplary Computing Environment

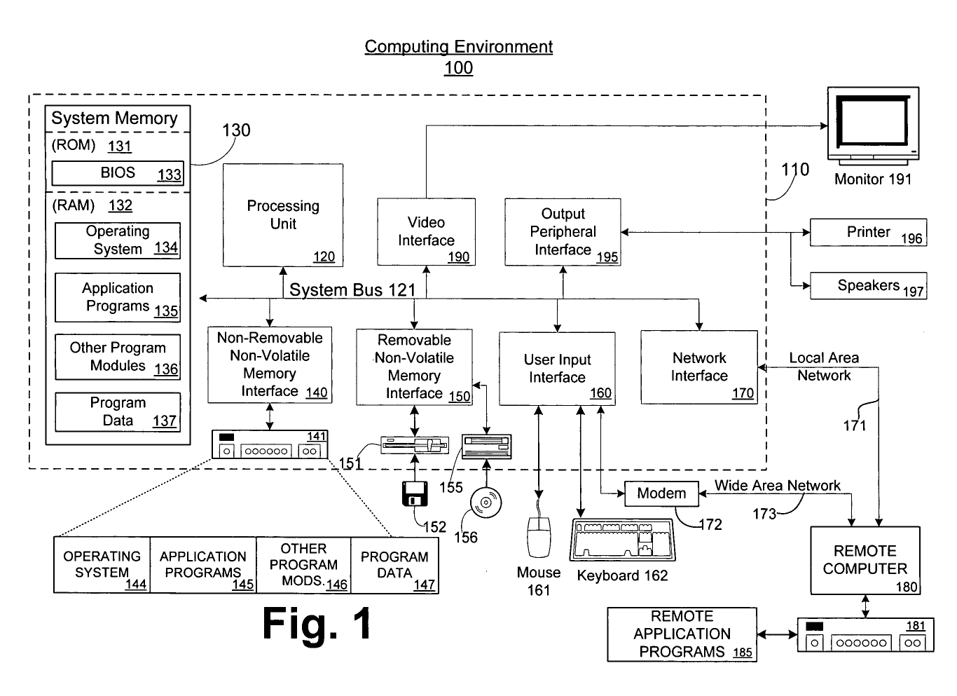

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 10 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), Peripheral Component Interconnect Express (PCI-Express), and Systems Management Bus (SMBus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 141 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Embodiments

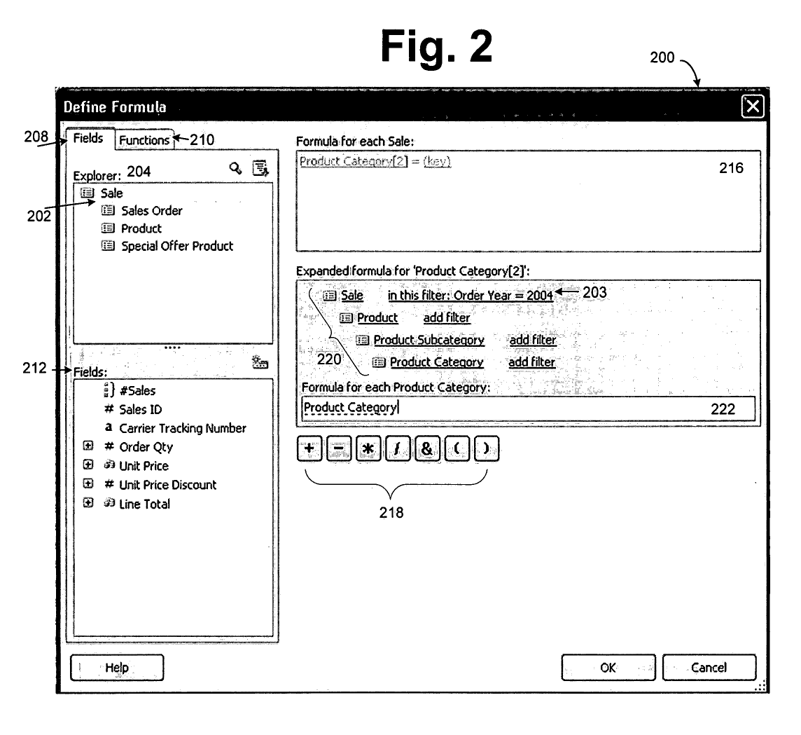

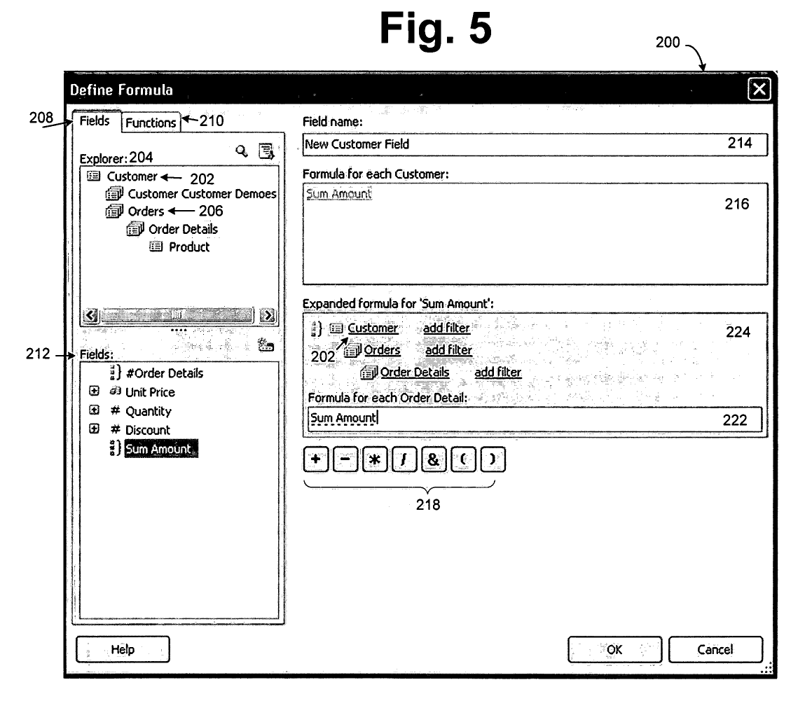

Referring now to FIGS. 2-5, an expression dialog 200 provides a vehicle for creating expressions/queries to be run against an entity relationship model. An entity 202 (e.g., Sale) serves as the focal point of the expression and impacts the data that will be returned. The entity 202 is displayed in an upper left hand corner of a navigator zone 204. From the dialog 200, users can create fields, edit formulas and set filtering options on an existing field. The entity 202, may or may not be the primary entity of the overall report.

When a relationship 206 (FIG. 5) from any entity is traversed, including the entity 202, the role name for the target entity is displayed hierarchically beneath the entity it was navigated from. A tree is formed from the entity 202 to all other entities involved in the expression which allows the user to easily see what entities and relationships are available to be used in the expression. Also, when an entity is selected in this zone the relationships from this entity are shown in this zone as possible navigation paths. The user may select one of these paths to navigate and add to the expression tree or chose a field from the field list zone. It also allows the user to quickly return to any entity used in the expression to add additional fields or traverse another relationship. If the user changes the primary entity of a report during the building of an expression, the navigation zone is reconstituted with the new entity at the root.

A fields tab 208 displays a navigation UI that presents fields 212 associated with a particular entity 202. When a new field is created, the model navigation is rooted at the entity for which the user selected to create the field. If launched to edit a field, the navigation reflects the definition of the item to be edited. A functions tab 210 allows users to select functions to use in their expression definition.

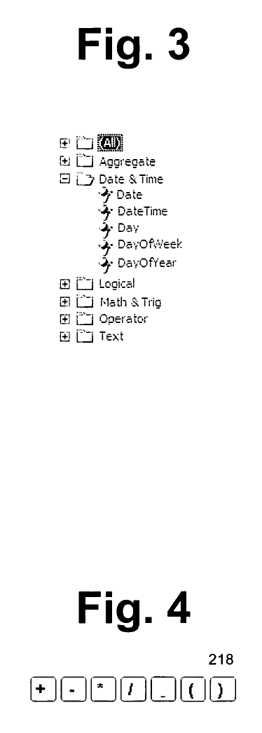

As shown in FIG. 3, functions are organized into categories which are represented as folders in the Function tab and displayed as shown below. The (All) folder shows all functions listed in alphabetical order. All other folders show their respective functions in alphabetical order when expanded also. Functions can be dragged and dropped from the function list to a location in a dialog box (e.g., 216, 222) when available. Operators, when dropped, show the symbol for the operator. Functions, when dropped, create a function syntax string in the Formula box.

A field name textbox 214 (FIG. 5) is provide for the user to indicate a unique name for the field to be listed in the field area for entity 202. A formula area 216 displays the definition of the current field. It is also the area where users may create or edit their field definitions. Users can drag and drop from the Fields or Formula tab into the formula area 216 or double click on items in either of these two tabs to add it to the formula area 216. The formula area 216 preferably behaves like a textbox with additional intelligence about functions and content. Generally, though, users can type and interact with the formula area 216 as they can with a textbox. Enhancements in the behavior of the formula area 216 include wrapping text in the formula area 216 and providing a vertical scroll bar enabled if the formula is longer than the display height.

When a function is dragged and dropped, the syntax text for that function is advantageously inserted into the formula box 216. Function names are displayed in, e.g., all capital letters and placeholders for function clauses are shown. Placeholders may be indicated by, e.g., yellow highlighting surrounding the clause text. Placeholder items are selected as an entire item, and a drag and drop function preferably replaces the entire placeholder.

When a field is dropped into the formula area 216, if the field has an expandable path, it is shown in, e.g., black text with a solid underline. If the field is has a terminal reference, the field is shown with a dotted underline. When an item is selected but focus is not in the Formula area, show the selected item, e.g., with gray background and dark gray text.

As shown in FIGS. 2, 4 and 5, operator buttons 218 provide users with a shortcut to writing simple expressions. Clicking on an operator button inserts the selected operator symbol to the current cursor position in the formula area 216. If the focus is not on the formula area 216, the operator is inserted at the end of any string in the formula area 216. These operators and additional operators are also accessible from the functions list.

From left to right, the exemplary operator buttons 218 include, but are not limited to: Add, Subtract, Multiply, Divide, Concatenate (an ampersand sign may be used), Left Parenthesis, Right Parenthesis. When a function name is selected in the formula, helper text (i.e., the name of the function followed by function description) may be shown below the operator buttons 218.

If an item selected has a path from an anchor entity 203 (e.g., Sale) of the expression, an expression path 220 for the item and the formula at the end is displayed. The path 220 consists of all relationships from the anchor entity 203 to the selected item and is displayed in an expansion area 224. Each item in the path 220 is indented similarly to the indentation in the model explorer. Path items may be shown in black underlined text.

Next to path items 220 is clickable text “add a filter.” When clicked, a context menu may drop down with options:

1. Create a new filter—launches the filter dialog so users can specify a filter at that level of the path

2. Use an existing filter—filter clauses other than the report filter are automatically named and reusable. This presents the user with a menu of existing filters from which a selection may be made. This option may be grayed out, unless reusable filters are available.

3. Remove filter—Enabled only if a filter is currently applied to the path item. When selected, removes the specified filter.

The formula area 216 shows the formula for the currently selected item in the path. A formula box 222 behaves similarly as the main formula area 216 in that it accepts drag and drop, etc. Changes are propagated back to the main formula area 216 when the user is done with the expansion. The expansion area 224 preferably persists once expanded until the user clicks again in the main formula area 216 so that users can navigate and select functions for their expanded formula.

When a formula is expanded and the user selects a “Create a filter” option on a path item, a filter dialog is launched so the user can specify the desired filter. Once the user has completed their filter specification and clicked “OK” on the filter dialog, the user is returned to the expression area 224 and the path 220 item name now followed by (filtered) as shown in FIG. 2. Other concise restatements of the filter (e.g., “Sales Orders (Order Year=2002)” may be used as appropriate. Filters can be set at none, any, or all of the path items for the expression.

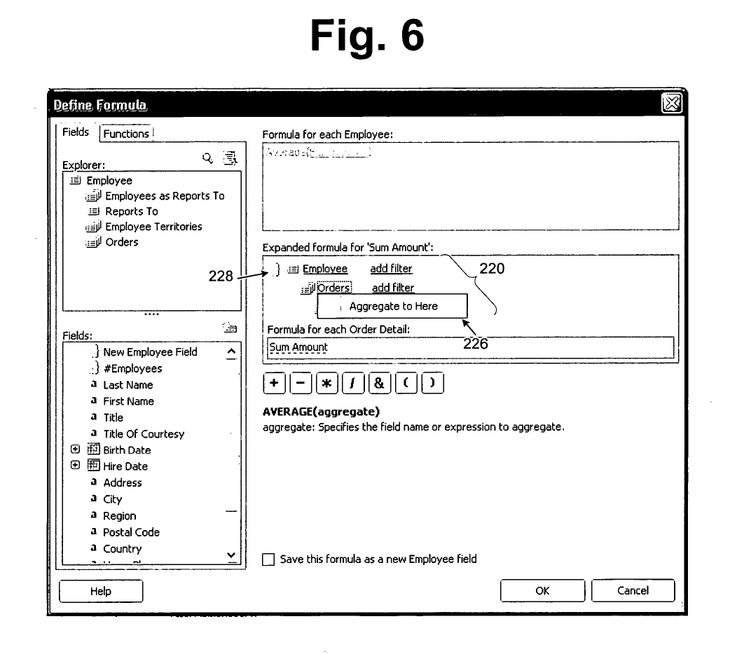

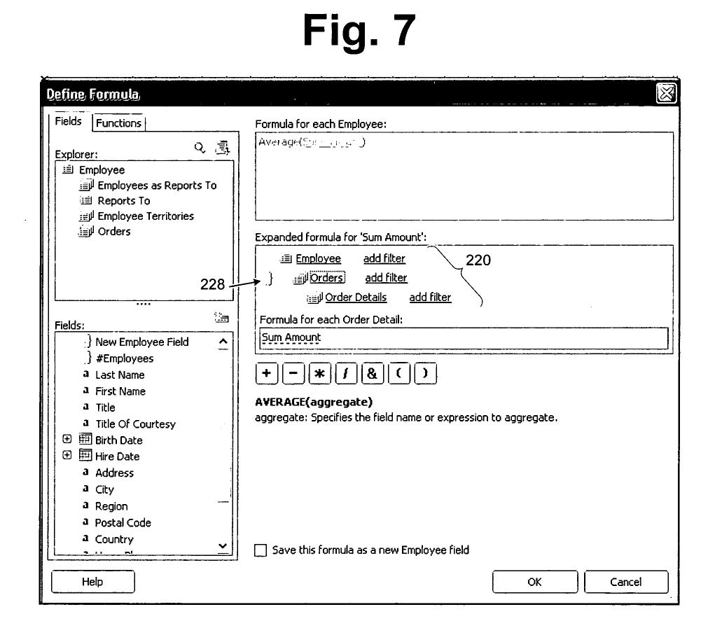

Referring to FIGS. 6-7, there is illustrated an “aggregate to here function” 226. In some instances, users wish to apply an aggregate function to a portion of the expression path 220. For example, to get the average Amount per Order across all Orders for an Employee, one could Sum the individual line totals per order (Sum Amount from Order Details) to the Order level, then Average the amounts per order for all orders for the employee. The Sum of the Amount stops at the Order level and is not applied to the Employee level.

To change the aggregation level, users click on the name of the path item where they would like to aggregate to (e.g., Orders) and select the “Aggregate to Here” option 226. An aggregation icon 228 specifies the level to which the aggregate will be applied. By default, all aggregates are applied to the top level. Any change to the aggregate function 226 will move the icon 228 to the new location.

When an “Aggregate to Here” option is selected, an Aggregate function is used to wrap the expression path at the selected aggregation point. For example Total Sales within the context of a customer is expressed as: Aggregate([Customer to Orders]Total Sales).

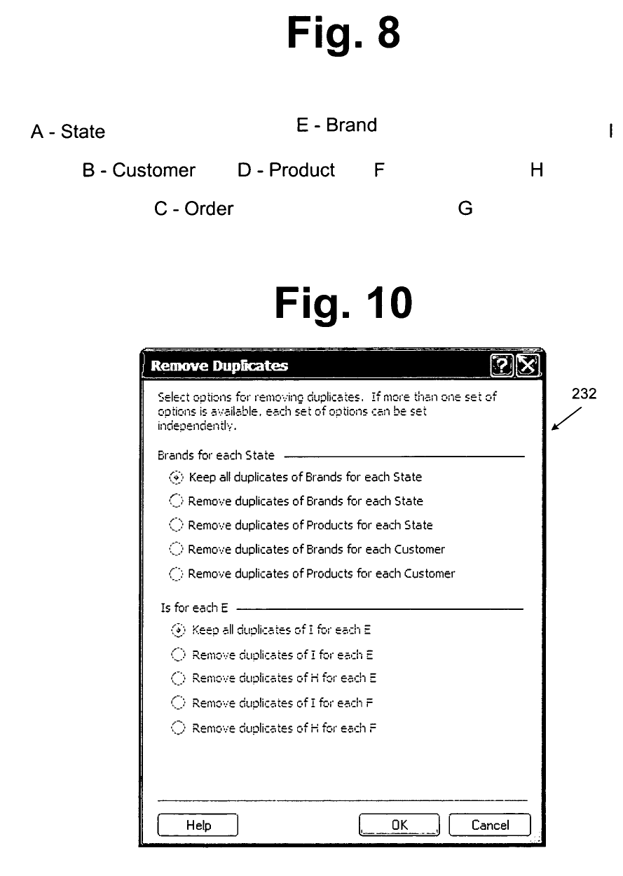

FIGS. 8-10 illustrate aspects of a remove duplicates function. As a simple example, an average Price may be calculated per customer along a path including Customers to Orders to Product where Price is an attribute of Product. The user may wish to find the average price for each distinct product the customer ordered or average the prices for each order the customer placed. In the first instance, all duplicates of products ordered by the customer are ignored in calculating the average price. In the second, only duplicates of products within the same order are removed. This function allows users to indicate at what parts of their path 220 they wish to remove duplicates. The default is to not remove duplicates at any point along the path. Duplicate removal is allowed on groups of path items around V points where a V point indicates moving from a “to many” to a “to one” relationship. For each V point, there are (m×n+1) combinations presented to the user indicating different duplicate removal options where m is the number of path items to the left of the V point and n is the number of path items to the right of the V point.

Referring to FIG. 8, there is an example of V points, where A−<B−<C>−D>−E−<F−<G>−H>−I, where −< indicates a one to many relationship and >− represents a many to one relationship, consists of 2 V points, Order (C) and G. For the V point at Order (C), there are (2×2+1)=5 options for removing duplicates representing combinations of m and n items and the default “keep duplicates” item.

These options are:

1. Keep all duplicates of brands for each state

2. Remove duplicates of brands for each state

3. Remove duplicates of products for each state

4. Remove duplicates of brands for each customer

5. Remove duplicates of products for each customer

Where keeping duplicates is indicated by the insertion of an Evaluate function indicating the entity context of the expression to be evaluated, the above translates to an expression as follows:

1. Keep all duplicates of brands (E) for each state (A) translates to [A to B to C]Evaluate([C to D to E]). This option is always the default and always represents the corresponding top levels of the V.

2. Remove duplicates of brands for each state translates to Evaluate([A to B to C to D to E]Evaluate([E])).

3. Remove duplicates of products for each state translates to Evaluate([A to B to C to D]Evaluate([D to E]))

4. Remove duplicates of brands for each customer translates to ([A to B]Evaluate([B to C to D to E]Evaluate([E]))).

5. Remove duplicates of products for each customer translates to ([A to B]Evaluate([B to C to D]Evaluate([D to E]))).

Likewise, 5 options are possible for the V point at G. Options for each V point can be set independently along the same path. Thus, for the given example, there are two sets of five options each that can be set independent of each other.

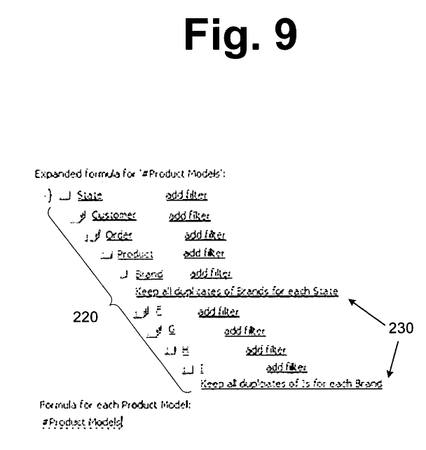

With reference to FIGS. 9-10, in the expression editor, the remove duplicates option is by default surfaced as a link 230 at the bottom of the expression path. The default option is to keep all duplicates. The text option is shown below the item representing the top right hand item for each of the V's in the path, i.e., below Brand (E) and below the entry for I.

When any of the remove duplicate items is clicked, a dialog 232 (FIG. 10) is shown, which provides options for the expression path. The dialog 232 has an introductory section followed by options grouped for each V within the expression. It is preferable that each group of options is separated by a group separator, where each group has a header indicating the <top right of the V> for each <top left of the V>. Beneath each group header a list the options for each V may be provided. Each set of options is independent of each other so users can select n options within this dialog where n corresponds to the number of groups within the dialog.

Thus, the present invention provides an intuitive method for users with varying levels of knowledge to create expressions that can be run against an entity relationship model to provide meaningful results. The expressions may include arithmetic and logical operators, as well as filters to limit and focus the results.

While the present invention has been described in connection with the preferred embodiments of the various Figs., it is to be understood that other similar embodiments may be used or modifications and additions may be made to the described embodiment for performing the same function of the present invention without deviating therefrom. For example, one skilled in the art will recognize that the present invention as described in the present application may apply to any computing device or environment, whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method of providing a facility to create an expression to query an entity relationship model, comprising:
providing a selection of an anchor entity of said expression;
providing a hierarchical tree from said anchor entity of roles related to said anchor entity;
providing fields associated with said anchor entity;
providing functions that are performed on said field; and
providing a formula area within which said expression is created from said fields and functions.

2. The method of claim 1, further comprising providing mathematical or logical operators that are inserted into said formula area.

3. The method of claim 1, further comprising:
organizing said functions into categories; and
displaying said categories as folders.

4. The method of claim 1, further comprising:
displaying an expression path for said anchor entity of said expression; and
displaying a formula box at an end of said expression path.

5. The method of claim 4, further comprising propagating changes made in said formula box to said expressions in said query in said formula area.

6. The method of claim 4, further comprising providing a context menu that provides data filtering options.

7. The method of claim 1, further comprising providing filters that restrict data associated with said anchor entity of said expression to be queried.

8. A computer readable medium containing computer executable instructions for providing a facility to create an expression to query an entity relationship model, said computer executable instructions performing the steps comprising:
providing a selection of a anchor entity and displaying associated roles in a hierarchical structure;
providing a list of fields associated with said anchor entity;
providing a list of functions that are performed on said field; and
providing a formula area within which said query is created from said fields and functions.

9. The computer readable medium of claim 8, further comprising instructions for providing mathematical or logical operators that are inserted into said formula area.

10. The computer readable medium of claim 8, further comprising instructions for organizing said functions into categories.

11. The computer readable medium of claim 8, further comprising instructions for:
displaying an expression path for said anchor entity; and
displaying a formula box at an end of said expression path.

12. The computer readable medium of claim 11, further comprising instructions for propagating changes made in said formula box to said expression within said query in said formula area.

13. The computer readable medium of claim 11, further comprising instructions for providing a context menu that provides data filtering options.

14. The computer readable medium of claim 8, further comprising instructions for providing filters that restrict data associated with said anchor entity queried by said query.

15. A method of creating an expression that is executed against an entity relationship model, comprising:
selecting an anchor entity;
selecting fields associated with said anchor entity;
selecting a function to be performed on a selected field; and
creating said expression from said fields and functions.

16. The method of claim 15, further comprising:
navigating an expression path associated with said anchor entity; and
entering a formula within a formula box at an end of said expression path that is propagated to said expression being created.

17. The method of claim 16, further comprising applying a filter to a field within said expression path wherein said filter restricts data displayed as a result of executing said expression.

18. The method of claim 17, further comprising selecting said filter from a context sensitive menu that provides data filtering options.

19. The method of claim 15, further comprising inserting a logical or mathematical operator into said formula bar.

20. The method of claim 15, further comprising creating said expression by dragging and dropping said fields onto a formula area in a user interface.
